(19) United States
(12) Patent Application Publication
(10) Pub. No.: US 2008/0062520 A1
(43) Pub. Date: Mar. 13, 2008

(54) METHOD AND APPARATUS FOR FABRICATING PROTECTION MEMBER FOR DISPLAY APPARATUS, METHOD FOR FABRICATING DISPLAY APPARATUS INCLUDING THE SAME AND DISPLAY APPARATUS INCLUDING THE SAME

(75) Inventors: Byoung-Hun LEE, Hwaseong-si (KR); Ho-Min KANG, Suwon-si (KR); Hee-Young PARK, Suwon-si (KR); Seung-Jun LEE, Yongin-si (KR); Jeong-Ho HWANG, Suwon-si (KR); Sung-Min KIM, Yongin-si (KR); Sung-Taek CHOI, Daegu-city (KR); Ho-Jeong KANG, Suwon-si (KR); Jong-Sig HYUN, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/747,557

(22) Filed: May 11, 2007

(30) Foreign Application Priority Data
May 12, 2006 (KR) 10-2006-043075
Oct. 20, 2006 (KR) 10-2006-102581

(51) Int. Cl. G02B 27/28

(52) U.S. Cl. 359/483; 29/822

(57) ABSTRACT

A method for fabricating a protection member for a display apparatus includes; vertically standing a protection panel with respect to a ground surface, disposing a protection cushion to stand vertically with respect to the ground surface and to face the protection panel, and attaching the protection cushion to the protection panel while the protection panel and the protection cushion remain vertically standing with respect to the ground surface.

This application claims priority to Korean Patent Application No. 2006-43075, filed on May 12, 2006, and Korean Patent Application No. 2006-102581, filed on Oct. 20, 2006, the contents of which in their entirety are herein incorporated by reference.

### BACKGROUND OF THE INVENTION

1. Field of the Invention

The present invention relates to a method and an apparatus for fabricating a protection member for a display apparatus and a method of fabricating a display apparatus including the same. More particularly, the present invention relates to a method and apparatus for fabricating a protection member, capable of improving yield and productivity, and a method of fabricating a display apparatus including the same.

2. Description of the Related Art

In general, a liquid crystal display (“LCD”) includes an LCD panel which displays an image thereon and a backlight assembly which provides light to the LCD panel. The LCD panel further includes a protection panel disposed at an upper portion thereof to protect the LCD panel, and a protection cushion is disposed between the protection panel and the LCD panel to absorb an externally provided shock. The protection cushion is attached to the protection panel by an adhesive coated over a face thereof.

In order to attach the protection cushion to the protection panel, the adhesion of the two takes place after the protection cushion is placed at a work stage. In this process, the protection cushion is placed to allow an adhesion face to be parallel to a ground surface, over which the adhesive is coated, and the protection panel faces the protection cushion. A ground surface is usually the floor of a room, but it could be any surface towards which particles are attracted. Since the adhesion face of the protection cushion is parallel to the ground surface, harmful foreign substances are readily attached to the protection cushion while attaching the protection cushion to the protection panel.

In order to prevent generation of air bubble between the protection panel and the protection cushion, the protection panel is attached to the protection cushion proceeding from a first end of the protection cushion to a second end, opposite to the first end, of the protection cushion. When pressing the protection panel to be adhered to the protection cushion, the protection panel may inadvertently be bent, thereby causing damage thereto. The inadvertent bending may be especially problematic when the protection panel includes a material which is vulnerable to an external impact, such as a glass, in which case the protection panel may become cracked.

A polarizer is disposed between the protection cushion and the LCD panel. First and second faces of the polarizer are attached to the LCD panel and the protection cushion, respectively. Processes for attachment of the polarizer and the protection panel to the LCD panel are performed while the LCD panel, the polarizer and the protection panel are aligned in parallel to the ground surface, and again harmful foreign substances may become attached to an adhesive formed on the polarizer.

### BRIEF SUMMARY OF THE INVENTION

The present invention provides a method for fabricating a protection member for a display apparatus, capable of improving yield and productivity.

The present invention also provides an apparatus for fabricating the protection member for the display apparatus.

The present invention also provides a method for fabricating the display apparatus using the above method.

In one exemplary embodiment of the present invention, an exemplary embodiment of a method for fabricating a protection member for a display apparatus includes vertically standing a protection panel with respect to a ground surface, disposing a protection cushion to stand vertically with respect to the ground surface and to face the protection panel, and attaching the protection cushion to the protection panel while the protection panel and the protection cushion remain vertically standing with respect to the ground surface.

In another exemplary embodiment of the present invention a method of fabricating a protection member for a display apparatus includes; vertically standing a protection panel with respect to a ground surface, disposing a protection cushion to stand vertically with respect to a ground surface and to face the protection panel, disposing the protection cushion to be spaced apart from and correspond to a cushion area of the protection panel, disposing a roller at a first end of the protection cushion, and moving the roller to a second end from the first end to attach the protection cushion to the protection panel, wherein the first and second ends are opposite to each other.

In another exemplary embodiment of the present invention, an apparatus for fabricating a protection member for a display apparatus includes a first vacuum pad which picks up a protection panel using a first vacuum and which vertically stands the protection panel with respect to a ground surface, a second vacuum pad which picks up a protection cushion using a second vacuum and which vertically stands the protection cushion with respect to the ground surface, and a roller which separates the protection cushion from the second vacuum pad and attaches the protection cushion to the protection panel, wherein the roller rotates about a rotation axis which is substantially vertical with respect to the ground surface.

In still another exemplary embodiment of the present invention, a method for fabricating a display apparatus includes plasma-treating a first face of a polarizer to form a first pattern on the first face of the polarizer, depositing an adhesive layer on the first pattern, vertically standing the polarizer with respect to a ground surface, vertically standing a display panel with respect to the ground surface, and attaching the polarizer on which the adhesive layer is formed to the display panel while the polarizer and the display panel remain vertically standing.

In another exemplary embodiment of the present invention the method further comprises plasma-treating a second face of the polarizer to form a second pattern on the second face of the polarizer, and the second face faces the first face, prior to vertically standing the polarizer.

In still another exemplary embodiment of the present invention, an apparatus for fabricating a display apparatus includes; a first vacuum pad which picks up a display panel using a first vacuum and vertically stands the display panel with respect to a ground surface, a second vacuum pad which picks up a polarizer using a second vacuum and vertically stands the polarizer with respect to the ground surface, and a roller which separates the polarizer from the second vacuum pad and attaches the polarizer to the display panel while being rotated, the roller having a rotation axis which is substantially vertical with respect to the ground surface.

In still another exemplary embodiment of the present invention, a display apparatus includes a display panel which displays an image using light provided form an exterior, a polarizer which polarizes at least one of the light form the exterior and light exiting through the display panel, the polarizer being disposed on a face of the display panel and provided with a first pattern formed on a first face thereof adjacent to the display panel, and an adhesive layer formed on the first face of the polarizer which attaches the polarizer to the display panel.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating an exemplary embodiment of an apparatus for fabricating a protection member for an exemplary embodiment of a display apparatus according to the present invention;

FIG. 2 is an exploded perspective view showing a relationship between an exemplary embodiment of a protection member and an exemplary embodiment of a liquid crystal display panel;

FIG. 3 is a front perspective view showing the exemplary embodiment of a protection panel of FIG. 2;

FIG. 4 is a front perspective view showing the exemplary embodiment of a protection cushion of FIG. 2;

FIG. 5 is a cross-sectional view taken along line I-I′ of FIG. 2;

FIG. 6 is a front perspective view showing the exemplary embodiment of an apparatus for fabricating the exemplary embodiment of a protection member of FIG. 1;

FIG. 7 is a front perspective view showing the first vacuum pad of FIG. 6;

FIG. 8 is a front perspective view showing the second vacuum pad and the roller of FIG. 6;

FIG. 9 is a flow chart illustrating an exemplary embodiment of a method of fabricating the exemplary embodiment of a protection member for the exemplary embodiment of a display apparatus according to the present invention;

FIG. 10 is a flow chart illustrating an exemplary embodiment of the method of positioning the protection panel of FIG. 9;

FIG. 11 is a flow chart illustrating an exemplary embodiment of the method of positioning the protection cushion of FIG. 9;

FIG. 12 is a flow chart illustrating an exemplary embodiment of the method of attaching the protection cushion of FIG. 9;

FIG. 13 is an overhead perspective view illustrating the exemplary embodiment of a method of attaching the protection cushion to the protection panel of FIG. 9;

FIG. 14 is an exploded perspective view showing an exemplary embodiment of a liquid crystal display according to the present invention;

FIG. 15 is a cross-sectional view taken along line II-II′ of FIG. 14;

FIG. 16 is a flow chart illustrating an exemplary embodiment of the method of fabricating the exemplary embodiment of a liquid crystal display according to the present invention;

FIG. 17 is a top plan view showing an exemplary embodiment of an apparatus for fabricating the polarizer shown in FIG. 15;

FIG. 18 is a side perspective view illustrating an exemplary embodiment of the process of forming the first concavo-convex pattern on the exemplary embodiment of a polarizer shown in FIG. 15;

FIG. 19 is a schematic illustrating a principle of forming the first pattern at the exemplary embodiment of a polarizer shown in FIG. 15;

FIG. 20 is a graph showing modification characteristics of the exemplary embodiment of a plasma-treated polarizer of FIG. 19;

FIG. 21 is a graph showing variation of the surface free energy according to a plasma treatment time;

FIG. 22 is a flow chart illustrating the process of attaching the exemplary embodiment of a polarizer to the exemplary embodiment of a liquid crystal display panel of FIG. 16;

FIG. 23 is an overhead perspective view showing the exemplary embodiment of a method of attaching the exemplary embodiment of a polarizer to the exemplary embodiment of a liquid crystal display panel of FIG. 14; and

FIG. 24 is a flow chart illustrating the exemplary embodiment of a process of coupling the exemplary embodiment of a protection panel to the exemplary embodiment of a liquid crystal display panel of FIG. 16.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, the present invention will be explained in further detail with reference to the accompanying drawings.

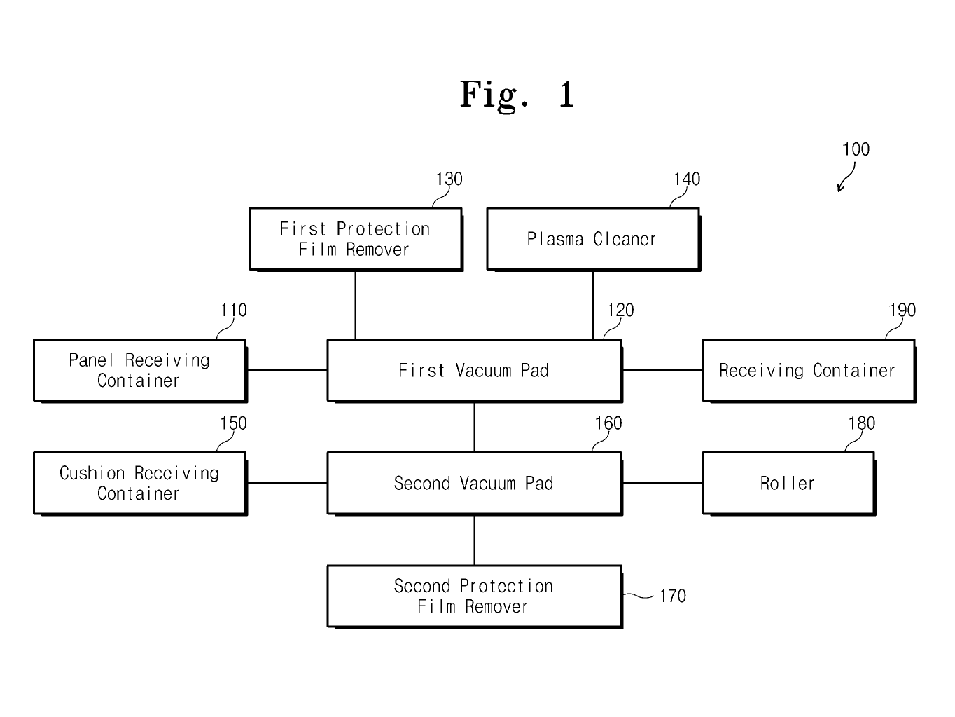

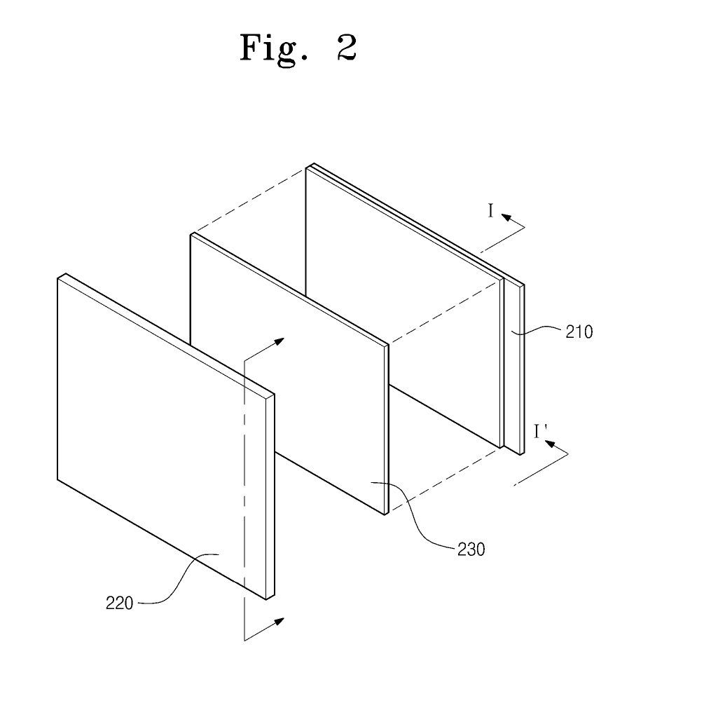

FIG. 1 is a block diagram illustrating an exemplary embodiment of an apparatus for fabricating a protection member for an exemplary embodiment of a display apparatus according to the present invention, and FIG. 2 is an exploded perspective view showing a relationship between an exemplary embodiment of a protection member and an exemplary embodiment of a liquid crystal display (“LCD”) panel.

Referring to FIGS. 1 and 2, an apparatus 100 for fabricating a protection member for a display apparatus attaches a protection cushion 230 to a protection panel 220 to absorb an impact. The protection panel 220 covers a display surface of an LCD 210 to protect the display surface from being scratched or cracked. The display surface of the LCD 210 is the same surface on which an image is displayed.

Hereinafter, structures of the protection panel 220 and the protection cushion 230 will be illustrated with reference to FIGS. 2 to 5.

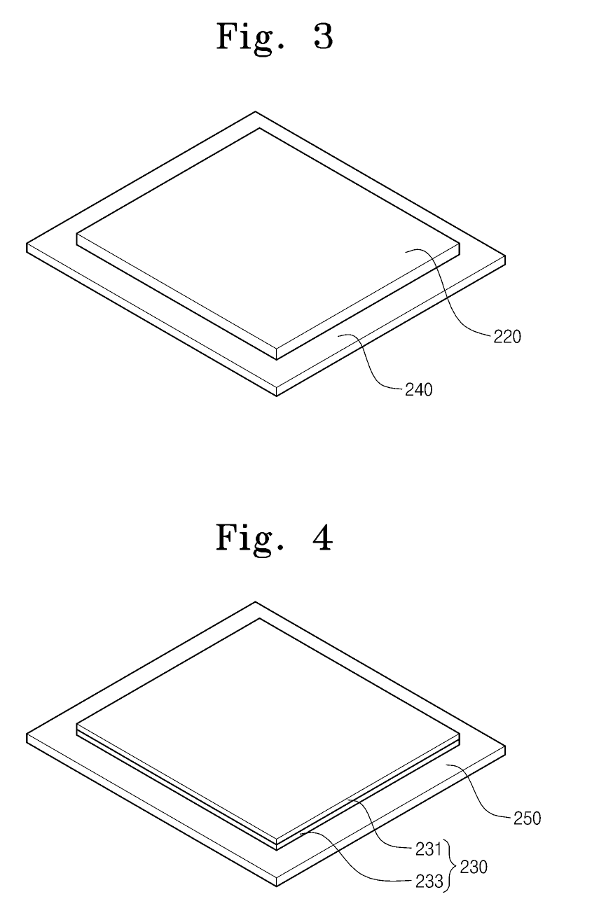

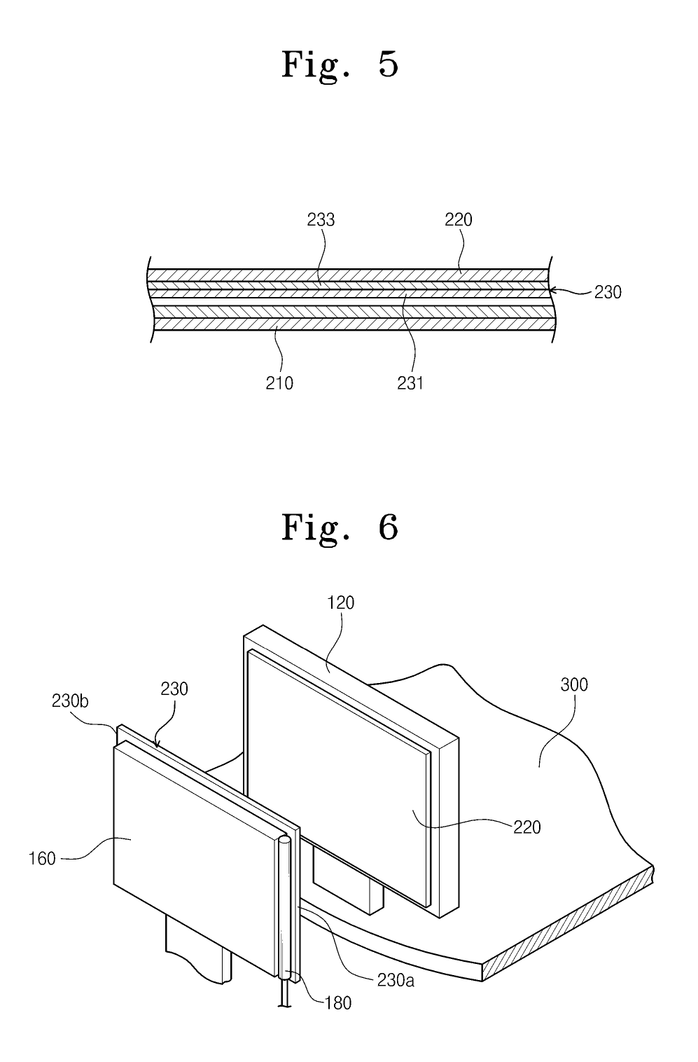

FIG. 3 is a front perspective view showing the exemplary embodiment of a protection panel of FIG. 2, FIG. 4 is a front perspective view showing the exemplary embodiment of a protection cushion of FIG. 2, and FIG. 5 is a cross-sectional view taken along line I-I′ of FIG. 2.

Referring to FIGS. 2 and 3, the protection panel 220 is disposed on the display surface of the LCD panel 210 to protect it. The protection panel 220 is a substrate including a transparent material through which light passes. The protection panel 220 includes a material which has a small degree of elasticity and is spaced apart from the LCD panel 210. A first protection film 240 is coupled to a first face of the protection panel 220.

Referring to FIGS. 4 and 5, the protection cushion 230 is disposed between the protection panel 220 and the LCD panel 210 to absorb impacts which may be applied to the LCD panel 210 from the direction of the protection panel 220. That is, in order to protect the LCD panel 210 from external impacts, the protection panel 220 is positioned apart from the LCD panel 210. Since the protection cushion 230 absorbs external impacts, a distance between the LCD panel 210 and the protection panel 220 may be reduced.

The protection cushion 230 includes a base sheet 231 and an adhesive member 233 formed on a face of the base sheet 231. Exemplary embodiments of the base sheet 231 include synthetic resin which allows light to pass therethrough and which also and absorbs external impacts. The adhesive member 233 is formed to attach the face of the base sheet 231 on which it is disposed to the protection panel 220.

A second protection film 250 is attached to a face of the adhesive member 233 to prevent foreign substances from becoming attached thereto. The second protection film 250 is only temporarily attached to the adhesive member 233, it is removed before the protection cushion 230 is attached to the protection panel 220.

Referring to again FIGS. 1 and 2, the fabrication apparatus 100 includes a panel receiving container 110, a first vacuum pad 120, a first protection film remover 130, a plasma cleaner 140, a cushion receiving container 150, a second vacuum pad 160, a second protection film remover 170, a roller 180 and a receiving container 190.

The panel receiving container 110 receives at least one protection panel such as the protection panel 220 and transfers it to another part of the apparatus 100. The protection panel 220 is received in the panel receiving container 110 after the first protection film 240 is attached to the protection panel 220.

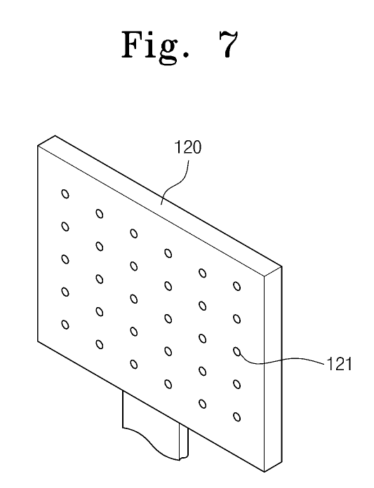

FIG. 6 is a front perspective view showing the exemplary embodiment of an apparatus for fabricating the exemplary embodiment of a protection member of FIG. 1, and FIG. 7 is a front perspective view showing the first vacuum pad of FIG. 6.

Referring to FIGS. 6 and 7, the first vacuum pad 120 picks up the protection panel 220 from the panel receiving container 110 using a vacuum. The first vacuum pad 120 is provided with a plurality of first vacuum holes 121 formed on a face of the first vacuum pad 120 to which the protection panel 220 is attached. The vacuum holes 121 create a vacuum or suction which attaches the protection panel 220 thereto. A second face of the protection panel 220, which is opposite the first face of the protection panel 220 to which the first protection film 240 is attached, makes contact with the first vacuum pad 120.

The first vacuum pad 120 is coupled to a work table 300, and the work table 300 rotates to adjust a position of the first vacuum pad 120. Particularly, the first vacuum pad 120 is coupled to the work table 300 using a hinge (not shown), and an angle between the face of the first vacuum pad 120 and the ground surface may be adjusted by moving the hinge.

Since the slope between the first vacuum pad 120 and the ground surface is adjustable, the protection panel 220 may be stood vertically with respect to the ground surface. Thus, the first vacuum pad 120 may prevent foreign substances from being deposited on the protection panel 220, thereby reducing contamination of the protection panel 220 in comparison with when the protection panel 220 is aligned in parallel to the ground surface.

Referring to FIGS. 1 and 6, the first protection film remover 130 removes the first protection film 240 from the protection panel 220 attached to the first vacuum pad 120. That is, the protection panel 220 is attached to the first vacuum pad 120 after attaching the first protection film 240 to the protection panel 220. When the work table 300 rotates in a predetermined direction and the first vacuum pad 120 to which the protection panel 220 is attached is moved to the first protection film remover 130, the first protection film remover 130 detaches the first protection film 240 from the protection panel 220.

The plasma cleaner 140 cleans a surface of the protection panel 220 from which the first protection film 240 is detached. In order to prevent the deterioration of the display quality, the plasma cleaner 140 cleans the surface of the protection panel 220 using the plasma, to which the protection cushion 230 is attached. The plasma cleaner removes foreign substances which would otherwise be attached to the protection panel 220. One exemplary embodiment of a cleaning method using the plasma, includes reacting the foreign substances with activated particles in the plasma and removing the foreign substances by colliding high-energy ions with the surface of the protection panel 220.

The protection cushion 230 is received in the cushion receiving container 150. The cushion receiving container 150 receives at least one protection cushion 150 to which the second protection film 250 is attached.

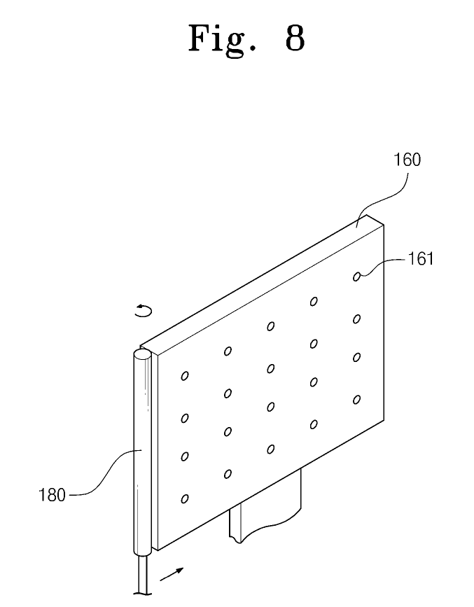

FIG. 8 is a front perspective view showing the second vacuum pad and the roller 180 of FIG. 6.

Referring to FIGS. 6 and 8, the second vacuum pad 160 picks up the protection cushion 230 from the cushion receiving container 150 using the vacuum generated by a plurality of second vacuum holes 161. The second vacuum holes 161 are formed in a face of the second vacuum pad 160 to which the protection cushion 230 will be attached. The second vacuum pad 160 makes contact with the base sheet 231 of the protection cushion 230.

In the current exemplary embodiment, an angle between the face of the second vacuum pad 160 which includes the second vacuum holes 161 and the ground surface may be adjusted, so that the protection panel 220 may be stood vertically with respect to the ground surface. Thus, the second vacuum pad 160 may prevent foreign substances from being deposited on the protection cushion 230, thereby reducing contamination of the protection cushion 230 in comparison with when the protection cushion 230 is aligned in parallel to the ground surface.

Referring again to FIGS. 1 and 6, the second protection film remover 170 removes the second protection film 250 from the protection cushion 230. That is, the second vacuum pad 160 picks up the protection cushion 230 to which the second protection film 250 is attached. The second protection film remover 170 detaches the second protection film 250 from the protection cushion 230 while the protection cushion 230 is attached to the second vacuum pad 160.

The roller 180 is disposed at a side of the second vacuum pad 160 to attach the protection cushion 230 to the protection panel 220. That is, the roller 180 proceeds from a first end 230a of the protection cushion 230 to a second end 230b of the protection cushion 230 while rotating in a predetermined direction to detach the protection cushion 230 from the second vacuum pad 160. The roller 180 attaches the protection cushion 230 detached from the second vacuum pad 160 to the protection panel 220. In the current exemplary embodiment, the protection cushion 230 has a higher flexibility than that of the protection panel 220, so that the protection cushion 230 is more readily deformed than the protection panel 220. Thus, the fabrication apparatus 100 of the protection member for the display apparatus may prevent damage to the protection panel 220 while attaching the protection cushion 230 to the protection panel 220. Because fewer displays are damaged during the fabrication process the yield of manufacturing may be increased.

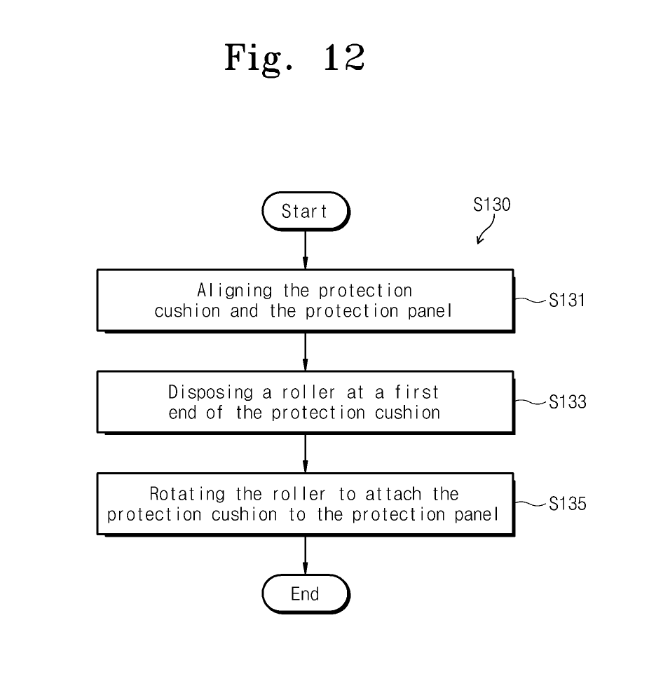

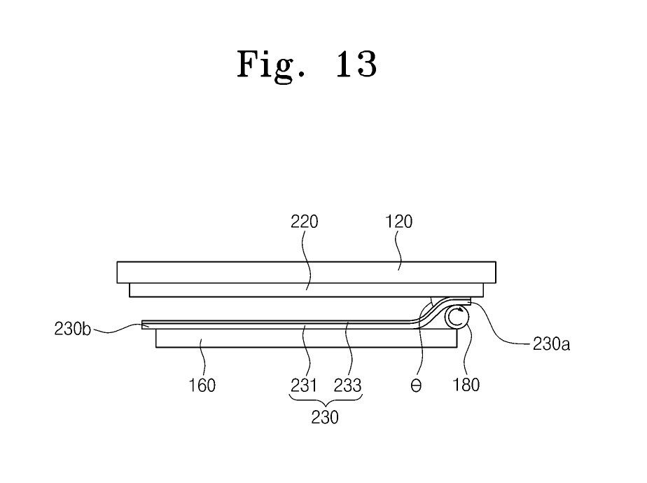

The process of attaching the protection cushion 230 to the protection panel 220 using the roller 180 will be described in more detail with reference to FIGS. 12 and 13.

The protection panel 220 to which the protection cushion 230 is attached is received in the receiving container 190. That is, when the protection cushion 230 is attached to the protection panel 220, the first vacuum pad 220 transfers the protection panel 220 to which the protection cushion 230 is attached to a means of conveyance which removes the combined protection panel 220 and protection cushion 230 for further processing. One exemplary embodiment of the means of conveyance is a conveyor belt (not shown). The means of conveyance transfers the protection panel 220 to the receiving container 190, and the receiving container 190 receives at least one protection panel 220. The receiving container 190 then transfers the protection panel 220 to wherever it is needed.

Hereinafter, a method of attaching the protection cushion 230 to the protection panel 220 will be described in detail with reference to drawings.

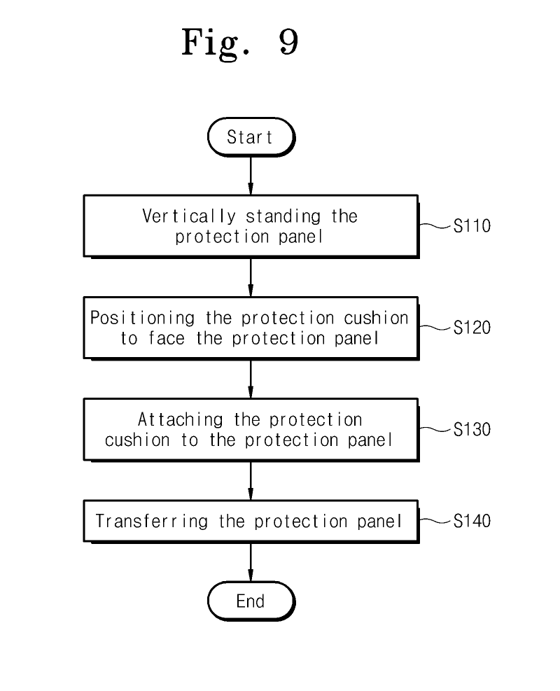

FIG. 9 is a flow chart illustrating an exemplary embodiment of a method of fabricating the exemplary embodiment of a protection member for the exemplary embodiment of a display apparatus according to the present invention.

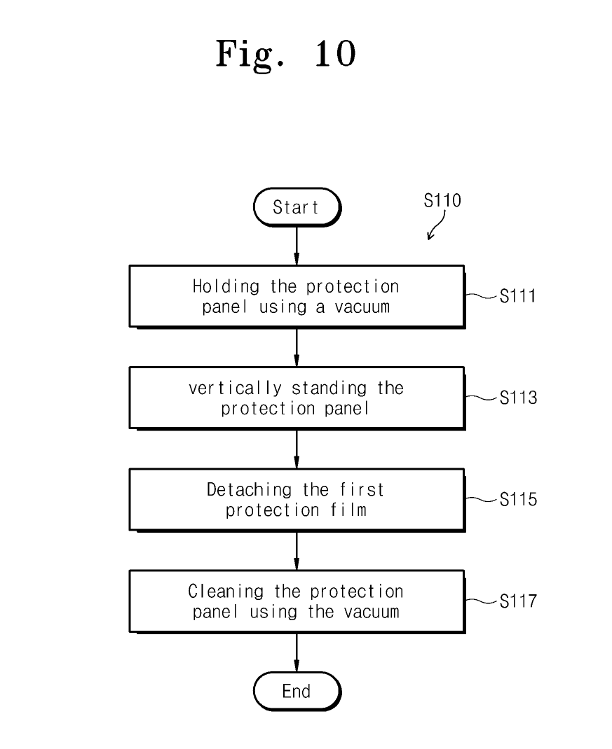

Referring to FIGS. 1, 2 and 9, the first vacuum pad 120 picks up the protection panel 220 from the panel receiving container 110 and stands the protection panel 220 vertically with respect to the ground surface (S110). The method of positioning the protection panel 220 will be described in more detail with reference to FIG. 10.

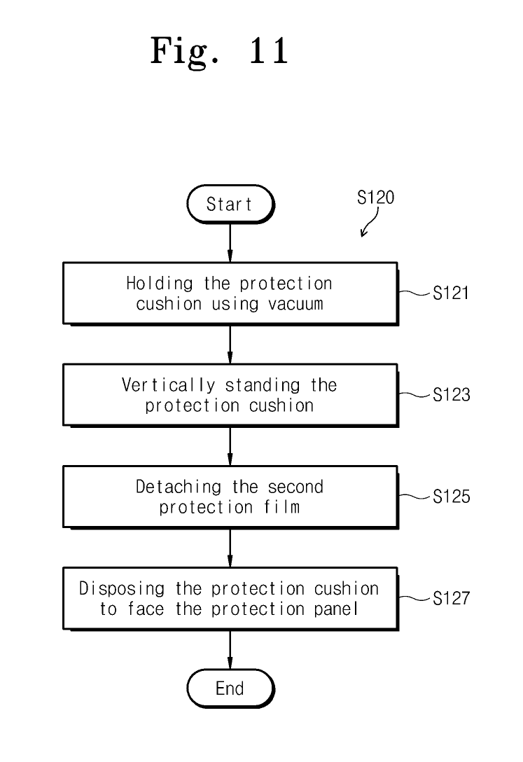

The second vacuum pad 160 picks up the protection cushion 230 from the cushion receiving container 150 and disposes the protection cushion 230 to face the protection panel 220 (S120). The method of positioning the protection cushion 230 will be described in more detail with reference to FIG. 11.

The roller 180 rotates in the predetermined direction to attach the protection cushion 120 to the protection panel 220 while the protection panel 220 and the protection cushion 230 are standing vertically stood (S130). The method of attaching the protection cushion 230 will be described in more detail with reference to FIG. 12.

The receiving container 190 receives the protection panel 220 to which the protection cushion 230 is attached and transfers the protection panel 220 to another part of the apparatus 100 (S140).

As described above, the fabrication apparatus 100 attaches the protection cushion 230 to the protection panel 220 after vertically standing the protection panel 220 and the protection cushion 230. Thus, the fabrication apparatus 100 may prevent foreign substances from being deposited on the protection panel 220 and the protection cushion 230, thereby improving the display quality of the display apparatuses manufactured thereby.

FIG. 10 is a flow chart illustrating an exemplary embodiment of the method for positioning the protection panel of FIG. 9.

Referring to FIGS. 1, 6 and 10, the first vacuum pad 120 holds the protection panel 220 received in the panel receiving container 110 using the vacuum generated by the first vacuum holes 121 (S111).

Then, the first vacuum pad 120 is placed vertically with respect to the ground surface, so that the protection panel 220 attached to the first vacuum pad 120 may be stood vertically with respect to the ground surface (S113).

The first protection film remover 130 detaches the first protection film 240 from the protection panel 220 (S115).

The plasma cleaner 140 cleans the protection panel 220 from which the first protection film 240 is detached using the plasma (S117). The protection cushion 230 is attached to the surface of the protection panel 220 which is cleaned by the plasma.

FIG. 11 is a flow chart illustrating an exemplary embodiment of the method of positioning the protection cushion of FIG. 9.

Referring to FIGS. 1, 6 and 11, the second vacuum pad 160 picks up and holds the protection cushion 230 received in the cushion receiving container 150 using the vacuum generated by the second vacuum holes 161 (S121).

Then, the second vacuum pad 160 is placed vertically with respect to the ground surface, so that the protection cushion 230 which is attached thereto may be stood vertically with respect to the ground surface (S123).

The second protection film remover 170 detaches the second protection film 250 from the protection cushion 230 (S125).

The second vacuum pad 160 is disposed to face the first vacuum pad 120, so that the protection panel 220 faces the protection cushion 230 (S127). In the current exemplary embodiment, the protection panel 220 and the protection cushion 230 are stood vertically with respect to the ground surface, and at the current stage of the assembly process the protection cushion 230 is spaced apart from the protection panel 220 at a predetermined distance.

The process of attaching the protection cushion 230 to the protection panel 220 using the roller 180 will be described in detail with reference to FIGS. 12 and 13.

FIG. 12 is a flow chart illustrating an exemplary embodiment of the method of attaching the protection cushion of FIG. 9, and FIG. 13 is an overhead perspective view illustrating the exemplary embodiment of a method of attaching the protection cushion to the protection panel of FIG. 9.

Referring to FIGS. 12 and 13, when the protection panel 220 and the protection cushion 230 are stood vertically with respect to the ground surface, the second vacuum pad 160 is adjusted such that the protection cushion 230 is placed at a position corresponding to a cushion area CA of the protection panel 220. Alternatively, the first vacuum pad 120 may have its position adjusted such that the cushion area CA of the protection panel 220 is placed at a position corresponding to the protection cushion 230 of the second vacuum pad 160 (S131). The cushion area CA is defined as the area on the protection panel 220 to which the protection cushion 230 is to be attached.

The roller 180 is disposed at the first end 230a of the protection cushion 230 (S133).

Then, the roller 180 proceeds from the first end 230a of the protection cushion 230 to the second end 230b of the protection cushion 230 while rotating in the predetermined direction to attach the protection cushion 230 to the protection panel 220. Accordingly, the roller 180 may prevent generation of an air bubble between the protection panel 220 and the protection cushion 230.

In the current exemplary embodiment, the roller 180 proceeds between the protection cushion 230 and the second vacuum pad 160, so that the protection cushion 230 is detached from the second vacuum pad 160. That is, the roller 180 detaches the protection cushion 230 from the second vacuum pad 160 and attaches it to the protection panel 220. In other words, the protection cushion 230 is attached to the protection panel 220 by the adhesive member 233 while being pressing by the roller 180.

Further, while the roller 180 rotates, a portion of the protection cushion 230, which is detached from the second vacuum pad 160, is attached to the protection panel 220, and a portion of the protection cushion 230, which is not detached from the second vacuum pad 160, remains on the second vacuum pad 160. Thus, the protection cushion 230 is partially bent when attached to the protection panel 220.

However, since the second vacuum pad 160 is spaced apart from the first vacuum pad 120 and the roller 180 may readily proceed in that space between the second vacuum pad 160 and the first vacuum pad 120, the fabrication apparatus 100 may prevent detachment of the protection cushion 230 from the second vacuum pad 160 before the portion of the protection cushion 230 which is detached from the second vacuum pad 160 is stably attached to the protection panel 220.

In the current exemplary embodiment, when the protection cushion 230 is bent, an angle θ between the protection cushion 230 and the protection panel 220 is about four degrees, but the angle θ may be varied due to various factors such as the suction forces of the first and second vacuum pads 120 and 160, a diameter of the roller 180, and various other factors. Also, the angle θ between the protection cushion 230 and the protection panel 220 depends on the distance between the first and second vacuum pads 120 and 160.

As described above, the roller 180 presses the protection cushion 230 to attach it to the protection panel 220. The protection cushion 230 includes the sheet having a higher flexibility than that of the protection panel 220, so that the protection cushion 230 is more readily deformed than the protection panel 220. Thus, the fabrication apparatus 100 may prevent damage to the protection panel 220 while attaching the protection cushion 230 to the protection panel 220, thereby improving the yield of the products.

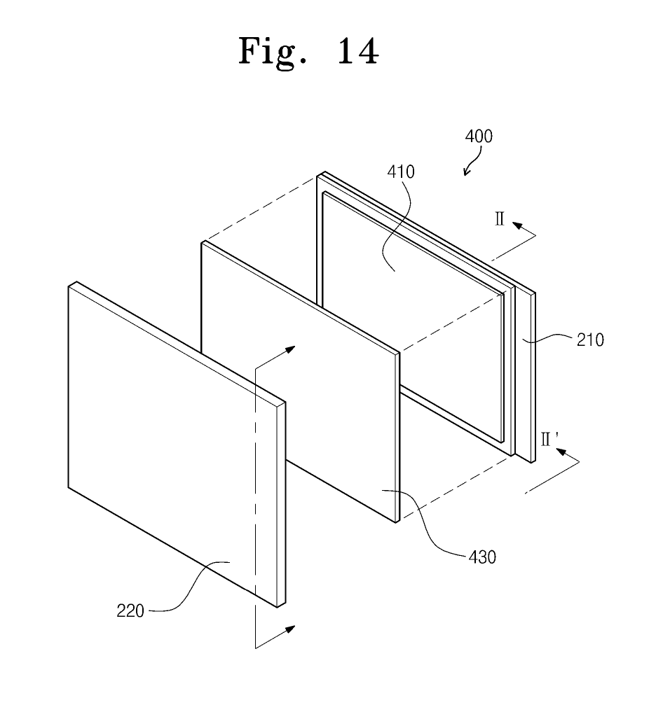

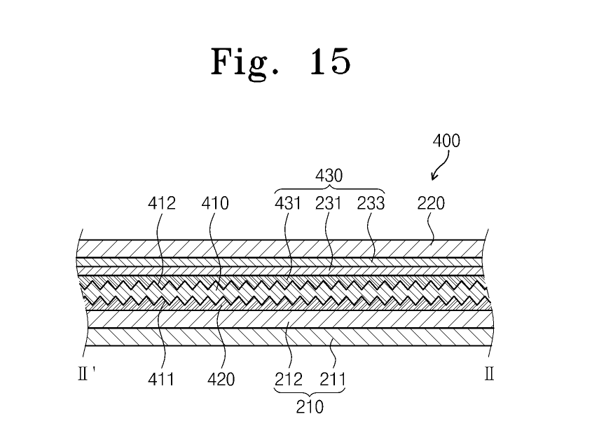

FIG. 14 is an exploded perspective view showing an exemplary embodiment of an LCD according to the present invention, and FIG. 15 is a cross-sectional view taken along line II-II′ of FIG. 14.

Referring to FIGS. 14 and 15, an exemplary embodiment of an LCD 400 includes an LCD panel 210, a protection panel 220, a polarizer 410, an adhesive layer 420 and a protection cushion 430. In the current exemplary embodiment, the LCD panel 210 and the protection panel 220 have substantially the same configurations and functions as those of the exemplary embodiments of the LCD panel 210 and the protection panel 220 shown in FIG. 2, and thus the same reference numerals are applied to the same elements and detailed descriptions of the same elements will be omitted in order to avoid redundancy.

The LCD panel 210 includes two substrates 211 and 212, exemplary embodiments of which may include a common electrode substrate and a thin film transistor substrate, coupled to each other and a liquid crystal layer (not shown) interposed between the two substrates 211 and 212. The liquid crystal layer controls the transmittance of light passing therethrough in accordance with an electric field formed between the two substrates 211 and 212 to display an image. The protection panel 220 covers the display surface, or the area on which an image is displayed, of the LCD panel 210 to protect the display surface from being scratched or cracked.

The polarizer 410 is disposed on the display surface of the LCD panel 210 to polarize the light from the LCD panel 210. The adhesive layer 420 is disposed between the polarizer 410 and the LCD panel 210 to attach the polarizer 410 to the LCD panel 210. The polarizer 410 is provided with a first pattern 411 formed at a first face thereof to enhance cohesive force between the polarizer 410 and the adhesive layer 420. That is, a contact area between the polarizer 410 and the adhesive layer 420 increases due to the increased surface area of the pattern 411, so that the cohesive force between the polarizer 410 and the adhesive layer 420 may be enhanced. In one exemplary embodiment the first pattern 411 has a concavo-convex shape.

Although not shown in figures, the LCD 400 may further include a polarizer disposed between the LCD panel 210 and a light source (not shown). In one exemplary embodiment the polarizer disposed between the LCD panel 210 and the light source may be provided with a concavo-convex pattern similar to the first pattern 411, which is formed at a surface adjacent to the LCD panel 210.

The protection cushion 430 is disposed between the polarizer 410 and the protection panel 220. Similar to the previously described exemplary embodiment, the protection cushion 430 may include a base sheet 231 and a first adhesive member 233 formed on an upper face of the base sheet 231. However, in the current exemplary embodiment, the protection cushion 430 includes a second adhesive member 431 formed on a lower face of the base sheet 231. In the current exemplary embodiment, the base sheet 231 and the first adhesive member 233 have substantially the same configurations and functions as those of the base sheet 231 and the adhesive member 233 of the exemplary embodiment shown in FIG. 5. Thus, the same reference numerals are applied to the same elements and detailed descriptions of the same elements will be omitted in order to avoid redundancy.

The first adhesive member 233 is disposed between the protection panel 220 and the base sheet 231 to attach the base sheet 231 to the protection panel 220. The second adhesive member 431 is disposed between the base sheet 231 and the polarizer 410 to attach the base sheet 231 to the polarizer 410. Thus, the LCD panel 210 and the protection panel 220 may be coupled to each other.

The polarizer 410 is provided with a second pattern 412 formed at a second face thereof to enhance cohesive force between the polarizer 410 and the second adhesive member 431. In one exemplary embodiment the second pattern 412 may be a concavo-convex pattern. A contact area between the polarizer 410 and the second adhesive member 431 is increased by the second pattern 412, so that the cohesive force between the polarizer 410 and the second adhesive member 431 may be enhanced.

Hereinafter, a method of fabricating the LCD 400 will be described in detail with reference to figures.

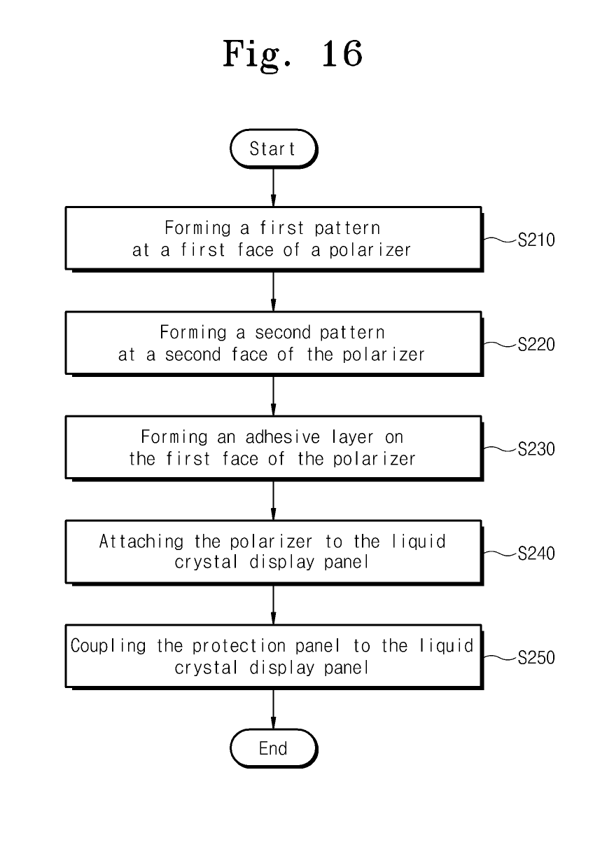

FIG. 16 is a flow chart illustrating an exemplary embodiment of the method of fabricating the exemplary embodiment of an LCD according to the present invention.

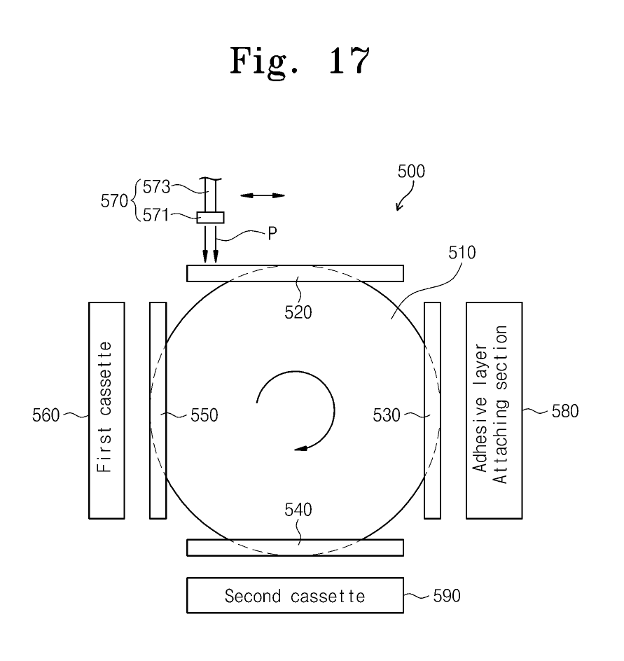

Referring to FIGS. 15 and 16, the first pattern 411 is formed at the first face of the polarizer 410 (S210). The second pattern 412 is formed at the second face of the polarizer 410 (S220). Exemplary embodiments of processes for forming the first pattern 411 will be described in detail with reference to FIGS. 17 to 19.

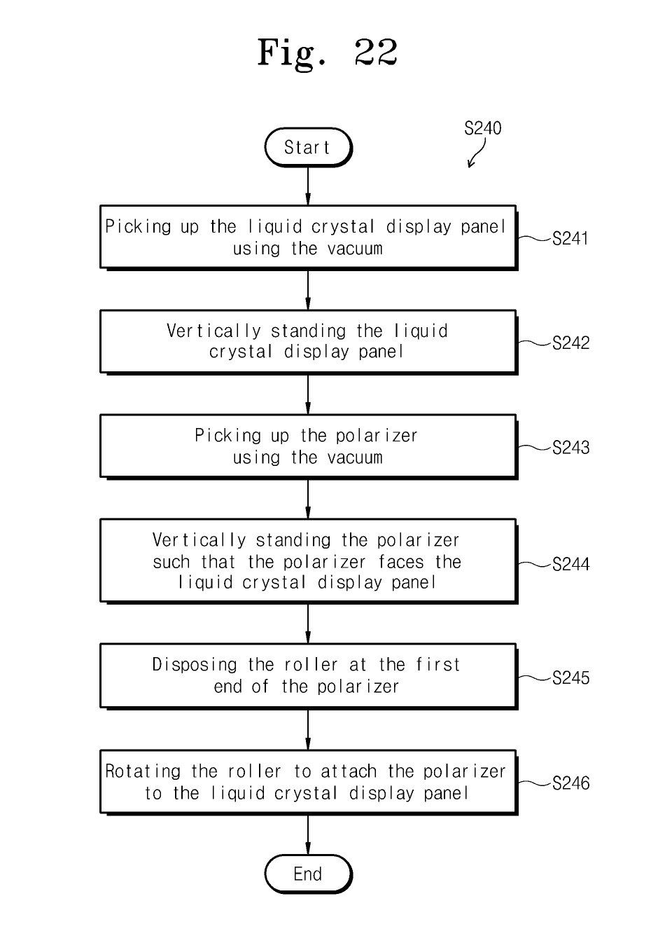

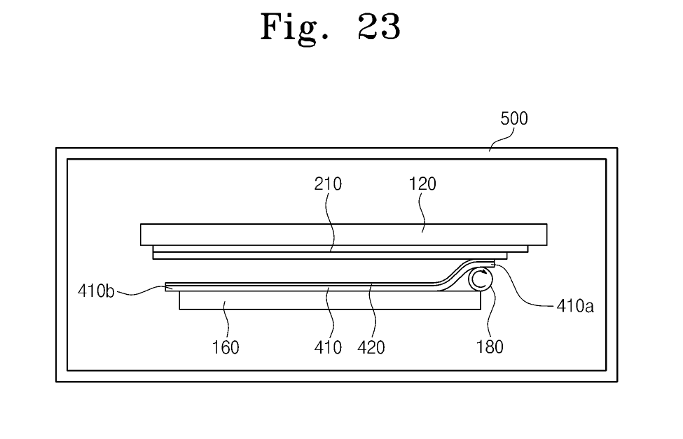

The adhesive layer 420 is formed on the first face of the polarizer 410, at which the first pattern 411 is formed (S230). Then the polarizer 410 is attached to the LCD panel 210 (S240). In one exemplary embodiment of the present invention, the polarizer 410 may be attached to the LCD panel 210 using the fabrication apparatus 100 shown in FIG. 1, and the processes of attaching the polarizer 410 will be described in detail with reference to FIGS. 22 and 23.

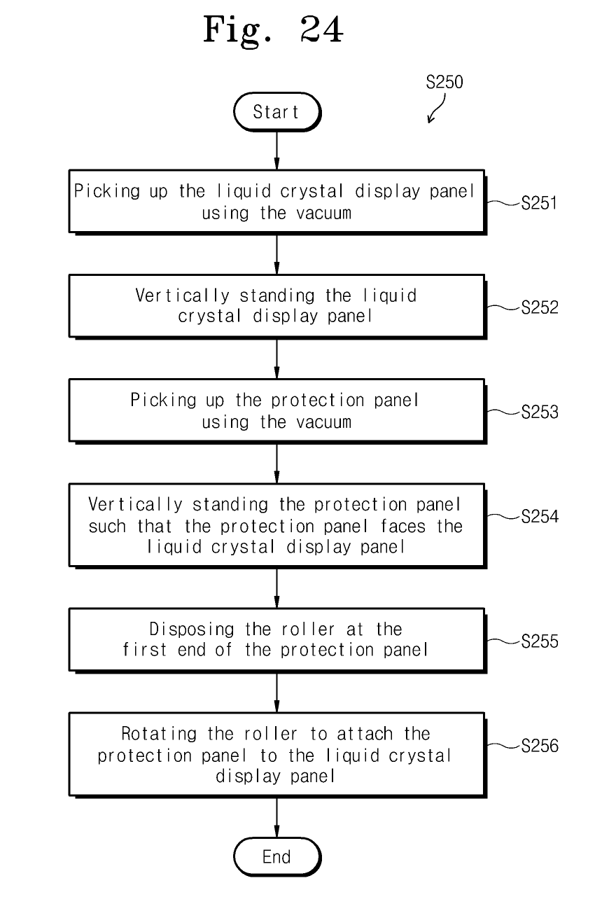

Then, the protection panel 220 is coupled to the LCD panel 210 (S240). Similarly, the protection panel 220 may be coupled to the LCD panel 210 using the exemplary embodiment of a fabrication apparatus 100 shown in FIG. 1, and the processes of coupling the protection panel 220 to the LCD panel 210 will be described in detail with reference to FIG. 24.

FIG. 17 is a top plan view showing an exemplary embodiment of an apparatus for fabricating the polarizer shown in FIG. 15.

Referring to FIGS. 15 and 17, the fabrication apparatus 500 includes a rotation stage 510 rotating in a predetermined direction, a plurality of picking up sections 520, 530, 540 and 550, a first cassette 560, a plasma processing section 570, an adhesive layer attaching section 580 and a second cassette 590.

The picking up sections 520, 530, 540 and 550 include first, second, third and fourth picking up sections 520, 530, 540 and 550, respectively, coupled to the rotation stage 510, and the first, second, third and fourth picking up sections 520, 530, 540 and 550 are spaced apart from each other. The first to fourth picking up sections 520, 530, 540 and 550 are located at edges of the rotation stage 510. The first picking up section 520 is disposed substantially opposite the third picking up section 540 with respect to the rotation stage 510, and the second picking up section 530 is disposed substantially opposite the fourth picking up section 550 with respect to the rotation stage 510. The first to fourth picking up sections 520, 530, 540 and 550 pick up the polarizer 410 from the first cassette 560 using a vacuum.

In the current exemplary embodiment, the first cassette 560 receives the polarizer 410 before the first and second patterns 411 and 412 are formed on the polarizer 410. Also, the first to fourth picking up sections 520, 530, 540 and 550 have substantially the same structure as that of the first vacuum pad 120, and thus detailed descriptions of the first to fourth picking up sections 520, 530, 540 and 550 will be omitted in order to avoid redundancy.

The first cassette 560, the plasma processing section 570, the adhesive layer attaching section 580 and the second cassette 590 are spaced apart from each other, and the rotation stage 510 is positioned in an area surrounded by the first cassette 560, the plasma processing section 570, the adhesive layer attaching section 580 and the second cassette 590. The plasma processing section 570 performs a plasma process on the polarizer 410 to form the first and second patterns 411 and 412. The adhesive layer attaching section 580 attaches the adhesive layer 420 to the polarizer 410 on the first pattern 411, and the second cassette 590 receives the polarizer 410 to which the adhesive layer 420 is attached.

In one exemplary embodiment, when the first picking up section 520 picks up the polarizer 410 from the first cassette 560, the rotation stage 510 rotates until the first picking up section 520 faces the plasma processing section 570. After forming the first and second patterns 411 and 412 on the polarizer 410 by the plasma processing section 570, the rotation stage 510 rotates such that the first picking up section 520 moves to the adhesive layer attaching section 580. The adhesive layer attaching section 580 attaches the adhesive layer 420 to the polarizer 410 which is being moved by the first picking up section 520. The rotation stage 510 continuously rotates to move the first picking up section 520 to the second cassette 590, and the polarizer 410 is deposited in the second cassette 590 by the first picking up section 520. The number of polarizers being operated on at any one time is only limited by the number of picking up sections and the size of the rotation stage 510.

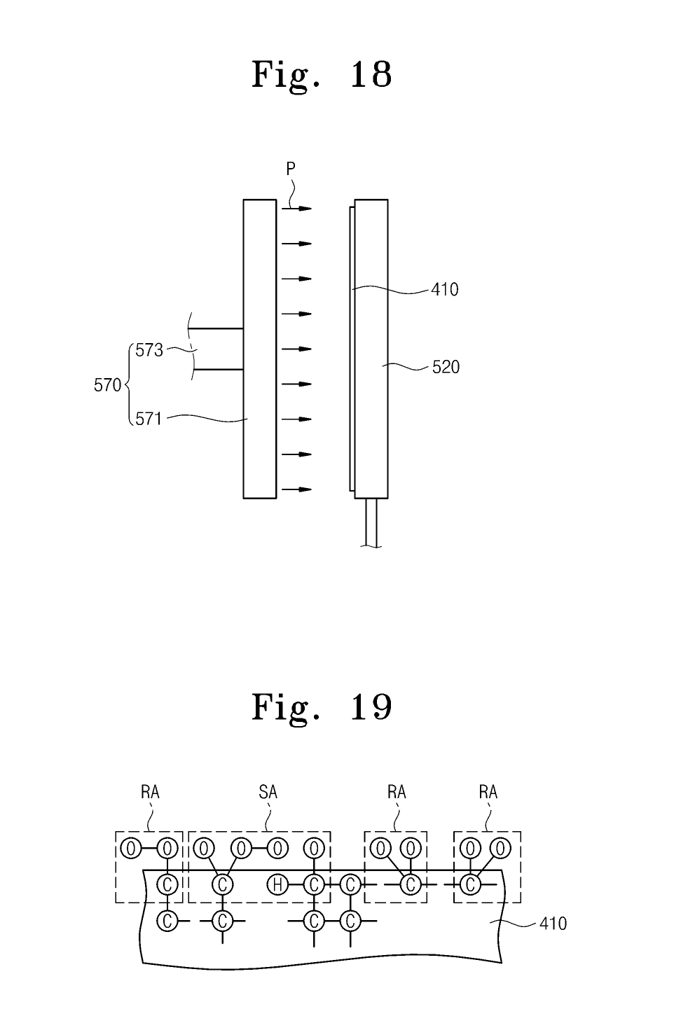

FIG. 18 is a side perspective view illustrating an exemplary embodiment of the process of forming the first concavo-convex pattern on the polarizer shown in FIG. 15, and FIG. 19 is a schematic illustrating a principle of forming the first pattern on the exemplary embodiment of a polarizer shown in FIG. 15.

Referring to FIGS. 17 to 19, the plasma processing section 570 includes a slit section 571 generating the plasma P and a gas supply section 573 supplying a plasma gas to the slit section 571. Although not shown in FIGS. 17 to 19, the slit section 571 includes electrodes to which voltages are applied to form the plasma P using the plasma gas. Exemplary embodiments of the plasma gas include nitrogen, argon, oxygen, air, and various other similar gasses. The plasma gas supplied through the gas supply section 573 passes between the electrodes, and the plasma P is generated by voltages applied to the electrodes.

The slit section 571 faces one of the first, second, third and fourth picking up sections 520, 530, 540 and 550 depending on the positioning of the rotation stage, and the plasma P generated from the slit section 571 is provided to one of the first, second, third or fourth picking up sections 520, 530, 540 and 550, which is facing the slit section 571. When the slit section 571 faces the first picking up section 520, the plasma P generated from the slit section 571 is provided to the polarizer 410 attached to the first picking up section 520. The slit section 571 provides the plasma P to the polarizer 410 while moving from a first end of the polarizer 410 to a second end of the polarizer 410, which is opposite to the first end. When supplying the plasma P to the polarizer 410, a distance between the slit section 571 and the polarizer 410 is uniformly maintained.

Referring to FIGS. 15 and 17, when the first face of the polarizer 410 is plasma-treated by means of the slit section 571, the first pattern 411 is formed at the first face of the polarizer 410. The plasma treatment process for the polarizer 410 in order to form the first and second patterns 411 and 412 is performed under the atmospheric pressure.

In one exemplary embodiment the polarizer 410 includes a resin material such as polymethylmethacrylate (“PMMA”) and includes carbon. As shown in FIG. 19, when the plasma P is supplied to the first face of the polarizer 410 from the slit section 571, carbon and hydrogen of the polarizer 410 are bonded with oxygen of the plasma P.

When the plasma treatment process of the first face of polarizer 410 is completed, the carbon of the polarizer 410 reacts with the oxygen of the plasma P to form carbon dioxide, or the bond between the carbon of the polarizer 410 and the oxygen of the plasma P is broken, thereby activating the first face of the polarizer 410. Portions RA of the polarizer 410 which have had their carbon atoms bonded with the oxygen of the plasma are removed, and portions SA where the bond between the carbon of the polarizer 410 and the oxygen of the plasma P is broken are not removed from the polarizer 410, so that the first pattern 411 may be formed at the first face of the polarizer 410 and the cohesive force between the first face of the polarizer 410 and the adhesive layer 420 may be enhanced due to the portions SA where the bond between the carbon of the polarizer 410 and the oxygen of the plasma P is broken.

As described above, when the first pattern 411 is formed at the first face of the polarizer 410 by the plasma treatment, the contact area between the polarizer 410 and the adhesive layer 420 increases and a surface free energy of the polarizer 410 is enhanced. Thus, the cohesive force between the polarizer 410 and the adhesive layer 420 may be enhanced, to thereby prevent the foreign substances or the air bubble from being formed between the polarizer 410 and the adhesive layer 420.

Similar to the first pattern 411, the second pattern 412 is formed at the second face of the polarizer 410 by plasma-treating the second face of the polarizer 410. In the current exemplary embodiment, the process of forming the second pattern 412 is substantially identical with that for the first pattern 411, and thus detailed description of the process of forming the second pattern 412 will be omitted in order to avoid redundancy.

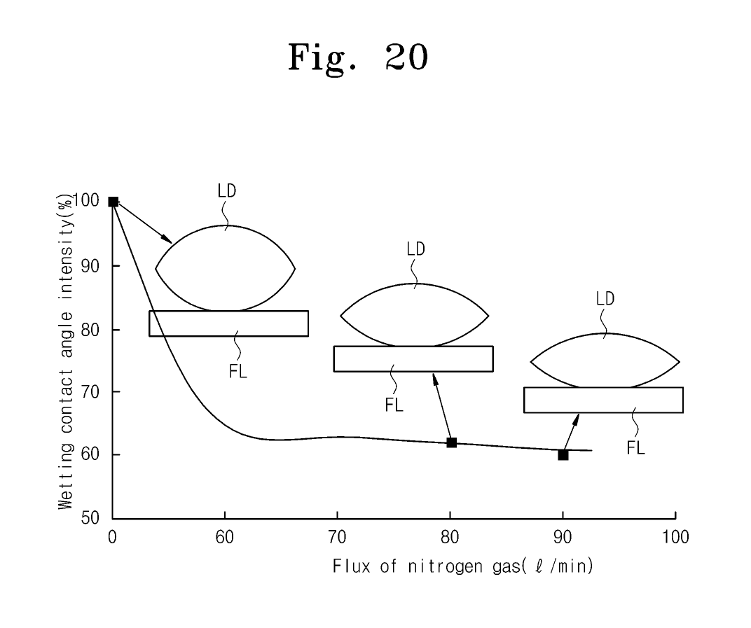

FIG. 20 is a graph showing modification characteristics of an exemplary embodiment of a plasma-treated film. In order to test the modification characteristics of the plasma-treated film, a contact angle between the plasma-treated film and a waterdrop dropped on the plasma-treated film has been measured. The graph shown in FIG. 20 also includes cross-sectional views of the plasma-treated film and waterdrop at three representational data points.

Referring to FIG. 20, when a film FL including a resin is plasma-treated, the contact angle between the plasma-treated film FL and the waterdrop LD decreases, so that a contact area between the plasma-treated film FL and the waterdrop LD increases. In other words, the surface free energy of the film FL increases when the plasma is irradiated onto the film FL, thereby increasing the contact area between the plasma-treated film FL and the waterdrop LD and enhancing the cohesive force between the plasma-treated film FL and the waterdrop LD. The contact area can be measured by the wetting contact angle intensity as shown in FIG. 20. The lower the contact angle intensity, the greater the adhesion between the film FL and the water drop LD. Similar to the film FL, the surface free energy of the polarizer 410 as shown in FIG. 15 increases due to the plasma treatment, and thus the cohesive force between the polarizer 410 and a foreign substance, e.g. the waterdrop, may be enhanced.

As shown in FIG. 20, the cohesive force between the plasma-treated film FL and the foreign substance is varied according to a flux of nitrogen gas used for plasma treatment of the film FL. That is, when the flux of nitrogen gas increases, the cohesive force between the plasma-treated film FL and the foreign substance may be further enhanced.

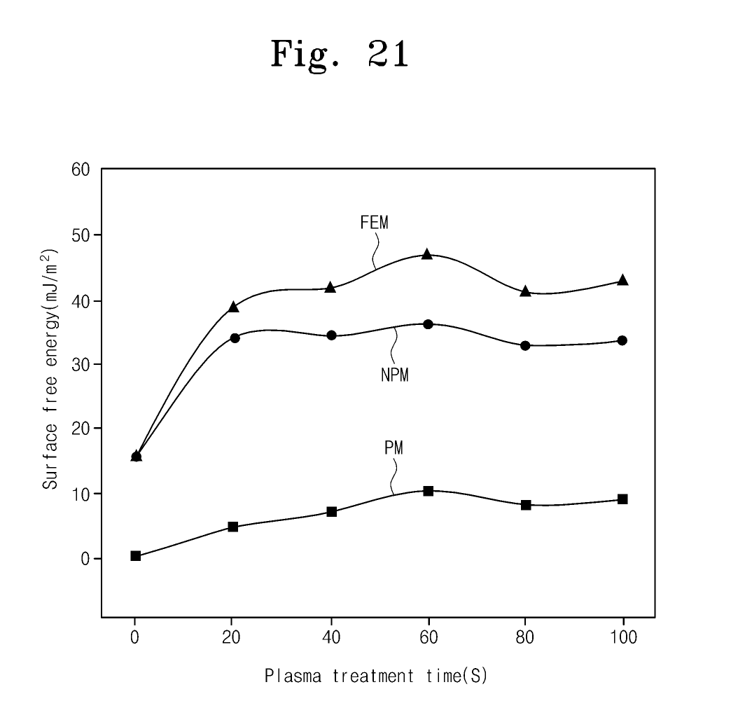

FIG. 21 is a graph showing variation of the surface free energy according to a plasma treatment time. Particularly, in FIG. 21, the variation of the surface free energy of a first material PM having a polarity, a second material NPM which does not have a polarity and a third material FEM having a free energy in accordance with the plasma treatment time are shown against a varying plasma treatment time.

Referring to FIG. 21, the surface free energies of the first, second and third materials PM, NPM and FEM are drastically enhanced between 0 second and 30 seconds after starting the plasma treatment, but the surface free energies of the first, second and third materials PM, NPM and FEM fluctuate within a substantially narrow range after 60 seconds.

As mentioned above, when the plasma treatment time exceeds a predetermined time limit, the surface free energies are not drastically varied. Thus, when the first and second patterns 411 and 412 are formed, the plasma treatment for the polarizer 410 is performed in a time range of about 30 seconds to about 60 seconds.

FIG. 22 is a flow chart illustrating the process of attaching the exemplary embodiment of a polarizer to the exemplary embodiment of an LCD panel of FIG. 16, and FIG. 23 is an overhead perspective view showing the exemplary embodiment of a method of attaching the exemplary embodiment of a polarizer to the exemplary embodiment of an LCD panel of FIG. 14.

Referring to FIGS. 1, 22 and 23, the first vacuum pad 120 of the fabrication apparatus 100 picks up the LCD panel 210 using the vacuum (S241).

The first vacuum pad 120 to which the LCD panel 210 is suctioned is stood vertically with respect to the ground surface such that the LCD panel 210 is placed vertically with respect to the ground surface (S242).

The second vacuum pad 160 of the fabrication apparatus 100 picks up the polarizer 410 to which the adhesive layer 420 is attached using the vacuum (S243). In order to safely pick up the polarizer 410, the second vacuum pad 160 holds the second face of the polarizer 410, where the adhesive layer 420 is not attached.

The second vacuum pad 160 is stood vertically with respect to the ground surface to allow the polarizer 410 to face the LCD panel 210 (S244).

Then, the roller 180 of the fabrication apparatus 100 is disposed at a first end 410a of the polarizer 410 while the LCD panel 210 and the polarizer 410 are stood vertically (S245).

The roller 180 proceeds from the first end 410a of the polarizer 410 to a second end 410b of the polarizer 410 while rotating in a predetermined direction to detach the polarizer 410 from the second vacuum pad 160. The roller 180 attaches the polarizer 410 detached from the second vacuum pad 160 to the LCD panel 210 (S246). Thus, the polarizer 410 may be attached to the LCD panel 210.

As shown in FIG. 23, in the current exemplary embodiment, the process of attaching the polarizer 410 to the LCD panel 210 is performed in a vacuum chamber 500, and the vacuum chamber 500 maintains a vacuum pressure in a range of about 1⁻³ Torr to about 500 Torr.

As described above, the polarizer 410 is attached to the LCD panel 210 while the polarizer 410 and the LCD panel 210 are vertically stood with respect to the ground surface, and the process of attaching the polarizer 410 to the LCD panel 210 is performed in the vacuum chamber 500. Thus, the fabrication apparatus 100 may prevent foreign substances or air bubbles from being formed between the polarizer 410 and the adhesive layer 420.

FIG. 24 is a flow chart illustrating the exemplary embodiment of a process of coupling the exemplary embodiment of a protection panel to the exemplary embodiment of an LCD panel of FIG. 16.

Referring to FIGS. 1, 15 and 24, the first vacuum pad 120 picks up the LCD panel 210, to which the polarizer 410 is already attached, using the vacuum (S251).

In order to vertically stand the LCD panel 210 with respect to the ground surface, the first vacuum pad 120 to which the LCD panel 210 is held is stood vertically with respect to the ground surface (S252).

The second vacuum pad 160 picks up the protection panel 220 to which the protection cushion 430 is attached using the vacuum (S253).

The second vacuum pad 160 is stood vertically with respect to the ground surface such that the protection panel 220 faces the LCD panel 210 attached to the first vacuum pad 120 (S254).

The roller 180 is disposed at a first end of the protection panel 220 while the LCD panel 210 and the polarizer 410 remain vertically standing (S255).

The roller 180 rotates in the predetermined direction to detach the protection panel 220 from the second vacuum pad 160 and attach the protection panel 220 detached from the second vacuum pad 160 to the LCD panel 210 (S256). Thus, the protection panel 220 may be coupled to the LCD panel 210.

According to the above exemplary embodiments, the fabrication apparatus the protection member for the display apparatus attaches the protection cushion to the protection panel while the protection cushion and the protection panel are vertically standing with respect to the ground surface. Thus, the fabrication apparatus may prevent deposition of the foreign substances between the protection cushion and the protection panel, thereby improving the yield of the products and the display quality of the display apparatus.

Also, since the fabrication apparatus presses the protection cushion to the protection panel, deformation of the protection panel during the attaching of the protection cushion to the protection panel may be avoided, to thereby improve the yield of the products.

Further, the first and second patterns are formed by plasma-treating the surface of the polarizer, so that the contact area between the polarizer and the adhesive layer and between the polarizer and the protection cushion increases, and the surface free energy of the polarizer increases. Accordingly, the cohesive force between the LCD panel and the protection cushion and between the LCD panel and the polarizer is enhanced, thereby preventing foreign substances and air bubbles from being formed between the adhesive layer, the protection cushion and the polarizer.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method for fabricating a protection member for a display apparatus, comprising:
vertically standing a protection panel with respect to a ground surface;
disposing a protection cushion to stand vertically with respect to the ground surface and to face the protection panel; and
attaching the protection cushion to the protection panel while the protection panel and the protection cushion remain vertically standing with respect to the ground surface.

2. The method of claim 1, wherein the attaching of the protection cushion comprises:
disposing the protection cushion to be spaced apart from and to correspond to a cushion area of the protection panel; and
attaching the protection cushion proceeding from a first end thereof to a second end thereof, which is opposite to the first end.

3. The method of claim 2, wherein the attaching of the protection cushion comprises:
disposing a roller at the first end of the protection cushion; and
moving the roller to the second end from the first end to attach the protection cushion to the protection panel.

4. The method of claim 3, wherein a region of the protection cushion is inclined about 4 degrees with respect to the protection panel when the roller is disposed between the first and second ends.

5. The method of claim 1, wherein the standing of the protection panel comprises:
attaching the protection panel to a first vacuum pad using a vacuum; and
vertically standing the first vacuum pad with respect to the ground surface.

6. The method of claim 5, wherein the disposing of the protection cushion comprises:
attaching the protection cushion to a second vacuum pad using the vacuum;
vertically standing the second vacuum pad with respect to the ground surface; and
positioning the second vacuum pad to allow the first vacuum pad to face the second vacuum pad.

7. The method of claim 1, further comprising cleaning the protection panel using plasma prior to attaching the protection cushion.

8. A method for fabricating a protection member for a display apparatus, comprising:
vertically standing a protection panel with respect to a ground surface;
disposing a protection cushion to stand vertically with respect to a ground surface and to face the protection panel;
disposing the protection cushion to be spaced apart from and correspond to a cushion area of the protection panel;
disposing a roller at a first end of the protection cushion; and
moving the roller to a second end from the first end to attach the protection cushion to the protection panel, wherein the first and second ends are opposite to each other.

9. An apparatus for fabricating a protection member for a display apparatus, comprising:
a first vacuum pad which picks up a protection panel using a first vacuum and which vertically stands the protection panel with respect to a ground surface;
a second vacuum pad which picks up a protection cushion using a second vacuum and which vertically stands the protection cushion with respect to the ground surface; and
a roller which separates the protection cushion from the second vacuum pad and attaches the protection cushion to the protection panel, wherein the roller rotates about a rotation axis which is substantially vertical with respect to the ground surface.

10. The apparatus of claim 9, wherein the first vacuum pad is provided with a plurality of first vacuum holes to hold the protection panel using the first vacuum.

11. The apparatus of claim 9, wherein the second vacuum pad is provided with a plurality of second vacuum holes to hold the protection cushion using the second vacuum.

12. The apparatus of claim 9, wherein the first vacuum pad is spaced apart from the second vacuum pad while attaching the protection cushion to the protection panel.

13. A method for fabricating a display apparatus, comprising:
plasma-treating a first face of a polarizer to form a first pattern on the first face of the polarizer;
depositing an adhesive layer on the first pattern;
vertically standing the polarizer with respect to a ground surface;
vertically standing a display panel with respect to the ground surface; and
attaching the polarizer on which the adhesive layer is formed to the display panel while the polarizer and the display panel remain vertically standing.

14. The method of claim 13, wherein the first pattern is formed by a reduction reaction between the polarizer and the plasma applied to the first face of the polarizer.

15. The method of claim 13, further comprising plasma-treating a second face of the polarizer to form a second pattern on the second face of the polarizer, the second face facing the first face, prior to vertically standing the polarizer.

16. The method of claim 15, wherein the second pattern is formed by a reduction reaction between the polarizer and the plasma applied to the second face of the polarizer.

17. The method of claim 15, wherein the plasma-treating is performed under an atmospheric pressure.

18. The method of claim 15, further comprising combining a protection panel with the display panel after attaching the polarizer to the display panel.

19. The method of claim 18, further comprising attaching a protection cushion to the protection panel prior to combining the protection panel with the display panel,
wherein the protection cushion is disposed between the protection panel and the display panel.

20. The method of claim 19, wherein the combining of the protection panel with the display panel comprises:
vertically standing the display panel with respect to the ground surface;
vertically standing the protection panel with respect to the ground surface;
positioning display panel and the protection panel to face each other; and
attaching the protection cushion to the second face of the polarizer while the display panel and the protection panel remain vertically standing with respect to the ground surface.

21. The method of claim 20, wherein the protection panel is combined with the display panel in a vacuum chamber maintained at vacuum.

22. The method of claim 21, wherein a vacuum pressure of the vacuum chamber is in a range of about 10⁻¹³ torr to about 500 torr.

23. The method of claim 15, wherein the first and second patterns are concavo-convex patterns.

24. An apparatus for fabricating a display apparatus, comprising:
a first vacuum pad which picks up a display panel using a first vacuum and vertically stands the display panel with respect to a ground surface;
a second vacuum pad which picks up a polarizer using a second vacuum and vertically stands the polarizer with respect to the ground surface; and
a roller which separates the polarizer from the second vacuum pad and attaches the polarizer to the display panel while being rotated, the roller having a rotation axis which is substantially vertical with respect to the ground surface.

25. The apparatus of claim 24, wherein the second vacuum pad picks up a protection panel to which a protection cushion is attached and vertically stands the protection panel with respect to the ground surface, and the roller separates the protection panel from the second vacuum pad and attaches the protection panel to the polarizer of the display panel with the protection cushion disposed between the protection panel and the polarizer.

26. A display apparatus comprising:
a display panel which displays an image using light provided from an exterior;
a polarizer which polarizes at least one of the light from the exterior and light exiting through the display panel, the polarizer being disposed on a face of the display panel and provided with a first pattern formed on a first face thereof adjacent to the display panel; and
an adhesive layer formed on the first face of the polarizer which attaches the polarizer to the display panel.

27. The display apparatus of claim 26, further comprising:
a protection panel disposed on the polarizer; and
a protection cushion attached to a face of the protection panel and disposed between the protection panel and the display panel which absorbs a shock applied to the display panel.

28. The display apparatus of claim 27, wherein the polarizer further comprises a second pattern formed on a second face facing the first face thereof, and the protection cushion is attached to the second face of the polarizer.

29. The display apparatus of claim 28, wherein the first and second patterns are concavo-convex patterns.
